(19) United States
(12) Patent Application Publication
(10) Pub. No.: US 2025/0083725 A1
(43) Pub. Date: Mar. 13, 2025

(54) DOUBLE-LAYER HORIZONTAL FOLDING CART

(71) Applicant: Zhejiang Pride Leisure Products Co,. Ltd., Jinhua (CN)

(72) Inventor: Benlong SUN, Jinhua (CN)

(21) Appl. No.: 18/829,249

(22) Filed: Sep. 9, 2024

(30) Foreign Application Priority Data
Sep. 8, 2023 (CN) 202322457599.9

(51) Int. Cl. B62B 3/02; B62B 3/10; B62B 5/06

(52) U.S. Cl. CPC B62B 3/02; B62B 3/106; B62B 5/065; B62B 2205/06

(57) ABSTRACT

A double-layer horizontal folding cart having a cart frame. The cart frame having a front frame, a back frame and a chassis riveted to a lower side of the front frame and a lower side of the back frame, wherein casters are arranged at the bottom of the front frame and the bottom of the back frame, and a hand lever is arranged on the front frame; the chassis having an upper layer and a lower layer, and each layer of the chassis having two bottom frames which are articulated symmetrically; and a baffle frame capable of being turned and opened to be horizontal is arranged on the back frame corresponding to the lower layer of the chassis. The double-layer horizontal folding cart can transport more articles every time, has higher transport efficiency, and can transport long and thin articles exceeding the length of the cart.

### BACKGROUND OF THE INVENTION

### 1. Technical Field

The invention belongs to the technical field of carts, and particularly relates to a double-layer horizontal folding cart.

### 2. Description of Related Art

In daily life, carts are used to transport various articles such as cargoes in some places where motor vehicles are inconvenient to use. Most existing carts are single-layer carts. For example, Chinese Patent Publication No. CN 219312839 U discloses a folding cart, wherein the folding cart has only one layer, so the space for storing articles during transportation is limited, and multiple times of transportation are needed in case of many articles; and four sides defining the storage space of the cart are connected and cannot be detached, and when an article exceeding the length of the storage space of the cart is transported, one end of the article is placed at the bottom of the storage space, the other end of the article will tilt upwards to the top of the sides of the cart, so the article is likely to roll during transportation due to its large inclination angle, which is not beneficial to safe transportation.

### BRIEF SUMMARY OF THE INVENTION

In view of the defects in the prior art, the objective of the invention is to provide a double-layer horizontal folding cart, which can transport more articles every time, has higher transport efficiency, and can transport long and thin articles exceeding the length of the cart.

To fulfill the above objective, the invention adopts the following technical solution: a double-layer horizontal folding cart comprises a cart frame, wherein the cart frame comprises a front frame, a back frame and a chassis riveted to a lower side of the front frame and a lower side of the back frame, casters are arranged at a bottom of the front frame and a bottom of the back frame, and a hand lever is arranged on the front frame; the chassis comprises an upper layer and a lower layer, and each layer of the chassis comprises two bottom frames which are articulated symmetrically; and a baffle frame capable of being turned and opened to be horizontal is arranged on the back frame corresponding to the lower layer of the chassis.

Further, the double-layer horizontal folding cart further comprises side frames with a front end riveted to the front frame and a back end riveted to the back frame, wherein the side frames are located above the chassis, and a length of the side frames in a front-back direction is adjustable.

Further, each of the side frames comprises an upper fence with an adjustable length in the front-back direction, the upper fence is arranged above the upper layer of the chassis, upper ends of front and back sides of the upper fence are riveted to the front frame and the back frame respectively, and lower ends of the front and back sides of the upper fence are slidably connected with the front frame and the back frame respectively.

Furthermore, the front frame and the back frame are identical in structure, the front frame comprises two support vertical tubes and at least one horizontal tube, two ends of the horizontal tube are connected with the two support vertical tubes, and the support vertical tubes are slidably connected with the lower ends of the front and back sides of the upper fence.

Furthermore, each of the side frames further comprises sliders, the lower ends of the front and back sides of the upper fence are riveted to the sliders respectively, and the sliders are slidably connected with the support vertical tubes.

Furthermore, each of the side frames further comprises a lower fence with an adjustable length in the front-back direction, the lower fence is arranged below the upper layer of the chassis, upper ends of front and back sides of the lower fence are slidably connected with the front frame and the back frame respectively, and lower ends of the front and back sides of the lower fence are riveted to front and back sides of the lower layer of the chassis respectively.

Further, the baffle frame is riveted to a lower end of the back frame, and left and right sides of the baffle frame are riveted to left and right sides of the back frame through length-adjustable connecting belts respectively.

Further, the hand lever is telescopic, and a lower end of the hand lever is rotatably connected with the front frame and is able to rotate forward and backward.

Further, the double-layer horizontal folding cart further comprises two storage bags arranged on the two layers of the chassis respectively, and a back side of the storage bag on the lower layer is openable.

Furthermore, visible areas are arranged on sides, corresponding to the side frames, of the storage bag on the lower layer.

By adopting the technical solution, the invention has the following beneficial effects: the cart has two layers, thus being able to transport more article every time; the back side of the cart can be opened, such that the cart can transport long and thin articles, inclination angle of articles placed in the cart is reduced, and the baffle frame can be turned to be horizontal to enlarge the contact area between the cart and articles, such that transportation is more convenient and faster, and the safety in the transportation process is improved; the storage bags can store various small articles, and the internal condition of the storage bag on the lower layer can be seen through the visible areas; the side frames and the chassis are foldable, and the handle lever is telescopic and can rotate to be close to the front frame, such that the cart can be folded when not used, and compared with carts that cannot be folded, the cart occupies less space, can be easily carried and used by users when users go out, and can be packaged in batches after production, and reduces packaging and transport costs.

### BRIEF DESCRIPTION OF THE SEVERAL VIEWS OF THE DRAWINGS

FIG. 1 is a three-dimensional view of a double-layer horizontal folding cart according to Embodiment 1;

FIG. 2 is an exploded view of the double-layer horizontal folding cart according to Embodiment 1;

FIG. 3 is a structural view of a cart frame of the double-layer horizontal folding cart according to Embodiment 1, from one perspective;

FIG. 4 is a structural view of the cart frame of the double-layer horizontal folding cart according to Embodiment 1, from another perspective;

FIG. 5 is a side view of the double-layer horizontal folding cart according to Embodiment 1;

FIG. 6 is a three-dimensional view of a double-layer horizontal folding cart according to Embodiment 2;

FIG. 7 is an exploded view of the double-layer horizontal folding cart according to Embodiment 2;

FIG. 8 is a structural view of a cart frame of the double-layer horizontal folding cart according to Embodiment 2, from one perspective;

FIG. 9 is a structural view of the cart frame of the double-layer horizontal folding cart according to Embodiment 2, from another perspective;

FIG. 10 is a side view of the double-layer horizontal folding cart according to Embodiment 2;

In the figures: 1, front frame; 11, support vertical tube; 12, horizontal tube; 13, fixed seat; 14, limiting part; 2, back frame; 3, chassis; 31, bottom frame; 4, side frame; 41, upper fence; 42, lower fence; 43, slider; 5, caster; 6, hand lever; 7, storage bag; 71, visible area; 72, mounting part; 8, baffle frame; 9, connecting belt; 90, adjusting buckle.

### DETAILED DESCRIPTION OF THE INVENTION

Specific embodiments of the specific solution of the invention will be further expounded below in conjunction with the accompanying drawings to gain a better understanding of the technical solution of the invention.

### Embodiment 1

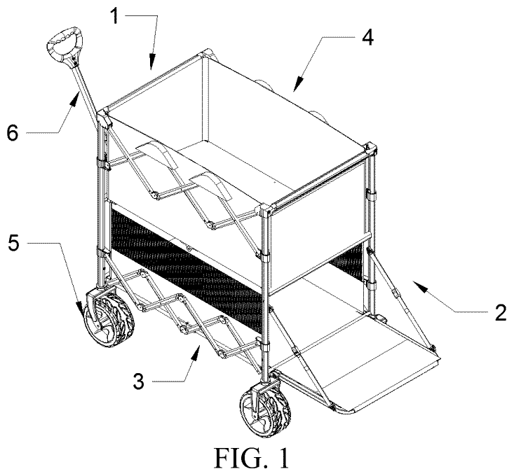

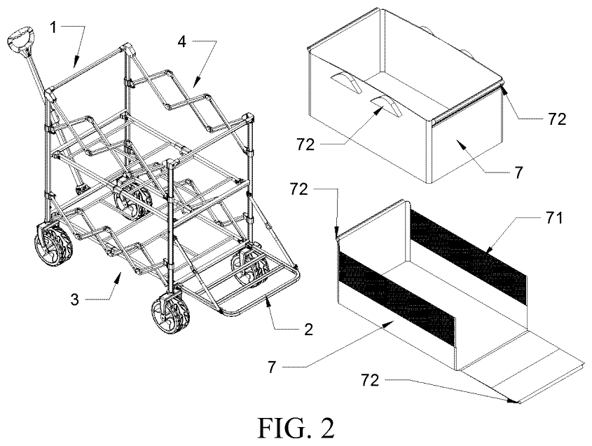

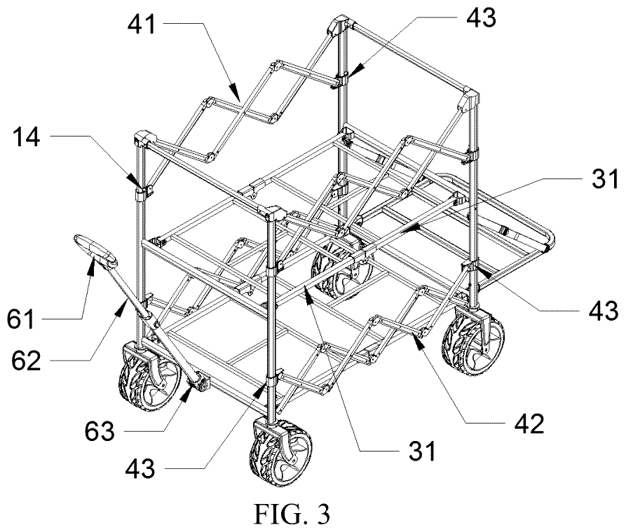

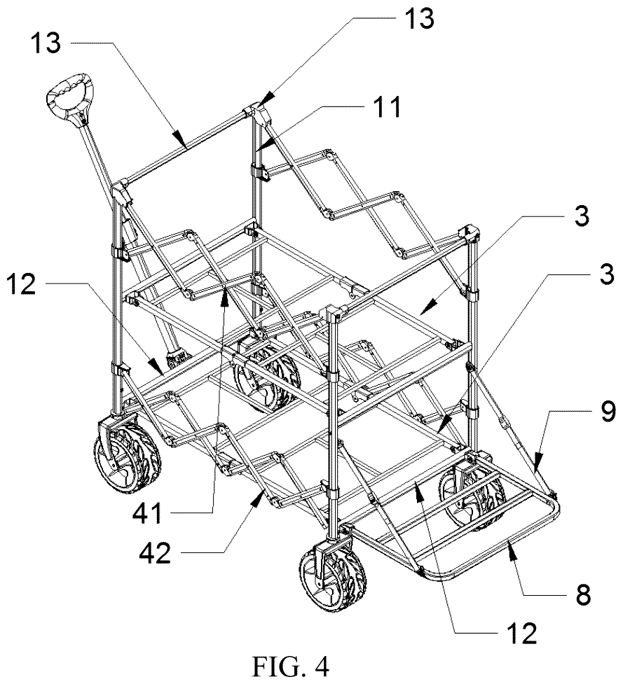

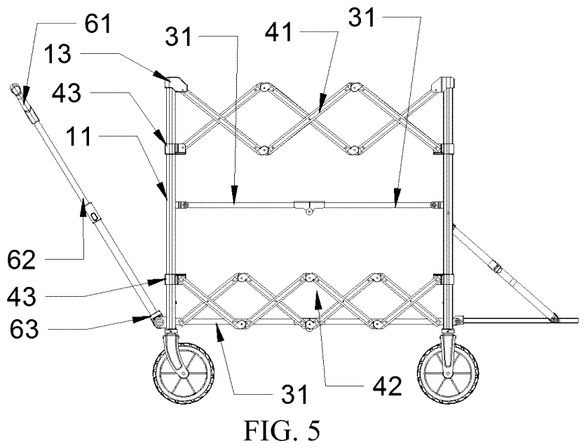

As shown in FIG. 1-FIG. 5, a double-layer horizontal folding cart comprises a cart frame, wherein the cart frame comprises a front frame 1, a back frame 2, and a chassis 3 riveted to a lower side of the front frame 1 and a lower side of the back frame 2, wherein casters 5 are arranged at the bottom of the front frame 1 and the bottom of the back frame 2, and a hand lever 6 is arranged on the front frame 1; the chassis 3 comprises an upper layer and a lower layer, and each layer of the chassis 3 comprises two bottom frames 31 which are articulated symmetrically; and a baffle frame 8 capable of being turned and opened to be horizontal is arranged on the back frame 2 corresponding to the lower layer of the chassis. When the cart frame needs to be folded, articulated joints at the center of the chassis 3 are pulled upwards to drive the lower surfaces of the two bottom frames 31 to move close to each other, and the front frame 1 and the back frame 2 riveted to the other ends of the bottom frames 31 are driven to move towards the center, such that the whole cart frame is horizontally folded.

The double-layer horizontal folding cart further comprises side frames 4 with a front end riveted to the front frame 1 and a back end riveted to the back frame 2, the side frames 4 are located above the chassis 3, and the length of the side frames in a front-back direction is adjustable.

Each of the side frames 4 comprises an upper fence 41 with an adjustable length in the front-back direction, wherein the upper fence 41 is arranged above the upper layer of the chassis 3, upper ends of front and back sides of the upper fence 41 are riveted to the front frame and the back frame respectively, lower ends of the front and back sides of the upper fence 41 are slidably connected with the front frame 1 and the back frame 2 respectively. The upper fence 41 is formed by one X-shaped cross tube or by multiple articulated X-shaped cross tubes, each X-shaped cross tube is formed by two riveted tubes, upper ends of every two adjacent X-shaped cross tubes are articulated, and lower ends of every two adjacent X-shaped tubes are articulated. Each X-shaped cross tube can be folded or unfolded, such that the side frames 4 can be horizontally folded quickly, and the front frame 1 and the back frame 2 can move towards the center directly.

The front frame 1 and the back frame 2 are identical in structure. The front frame 1 comprises two support vertical tubes 11 and at least one horizontal tube 12, wherein two ends of the horizontal tube 12 are connected with the two support vertical tubes 11; and the support vertical tubes 11 are slidably connected with the lower ends of the front and back sides of the upper fence 41, and the casters 5 are mounted at the bottoms of the support vertical tubes 11. In this embodiment, three parallel horizontal tubes 12 are adopted, the top horizontal tube is fixed to the tops of the support vertical tubes 11 through fixed seats 13, the middle horizontal tube is riveted to the upper layer of the chassis 3, and the bottom horizontal tube is riveted to the lower layer of the chassis 3. An upper end of the front side or back side of the upper fence 41 is riveted to the corresponding fixed seat 13.

Specifically, each of the side frames further comprises sliders 43, wherein lower ends of the front and back sides of the upper fence 43 are each riveted to the sliders 43, and the sliders 43 are slidably connected with the support vertical tubes 11. Vertical holes are formed in the sliders 43, and the sliders 43 are disposed around the support vertical tubes 43 through the holes and are able to slide upwards and downwards. In order to prevent the sliders from sliding upwards excessively, limiting parts 14 are arranged on tube walls of the support vertical tubes 11 to limit the maximum upward sliding height of the sliders 43.

Each of the side frames 4 further comprises a lower fence 42 with an adjustable length in the front-back direction, wherein the lower fence 42 is arranged below the upper layer of the chassis 3, upper ends of front and back sides of the lower fence 42 are slidably connected with the front frame 1 and the back frame 2 respectively, and lower ends of the front and back sides of the lower fence 42 are riveted to front and back sides of the lower layer of the chassis 3.

The baffle frame 8 is riveted to a lower end of the back frame 2. Specifically, the baffle frame 8 is riveted to the horizontal tube 12 at the lower end of the back frame 2. Left and right sides of the baffle frame 8 are riveted to left and right sides of the back frame 2 through length-adjustable connecting belts 9 respectively.

The hand lever 6 is telescopic, and a lower end of the hand lever 6 is rotatably connected with the bottom horizontal tube 12 of the front frame 1 and is able to rotate forward or backward. The hand lever 6 comprises a handle 61, a telescopic tube 62 and a handle base 63 which are sequentially arranged from top to bottom, two ends of the telescopic tube 62 are fixed to the handle 61 and the handle base 63 respectively, and the handle base 63 is riveted to the bottom horizontal tube 12 of the front frame 1 and is able to rotate forward and backward.

Two storage bags 7 are arranged on the two layers of chassis 3 respectively, a back side of the storage bag 7 on the lower layer is openable, and the corresponding baffle frame 8 is turnable, such that long and thin articles can be placed in the storage bag. Mounting parts 72 may be arranged on four sides of the storage bag 7 on the upper layer, the mounting parts are hook-and-loop fasteners, structures with bottom openings, or other fixing parts, front and back sides of the storage bag 7 are wound on the top horizontal tube of the front frame 1 and the top horizontal tube of the back frame 2 to be fixed, and left and right sides of the storage bag 7 are mounted on the articulated joint of the upper ends of the two X-shaped cross tubes of the upper fence 43 of one side frame 4 and the articulated joint of the upper ends of the two X-shaped cross tubes of the upper fence 43 of the other side frame 4 through structures with bottom openings.

Visible areas 71 are arranged on sides, corresponding to the side frames, of the storage bag 7 on the lower layer. In this embodiment, the visible areas are hollowed-out structures, and multiple through-holes are formed in local sides of the visible areas.

### Embodiment 2

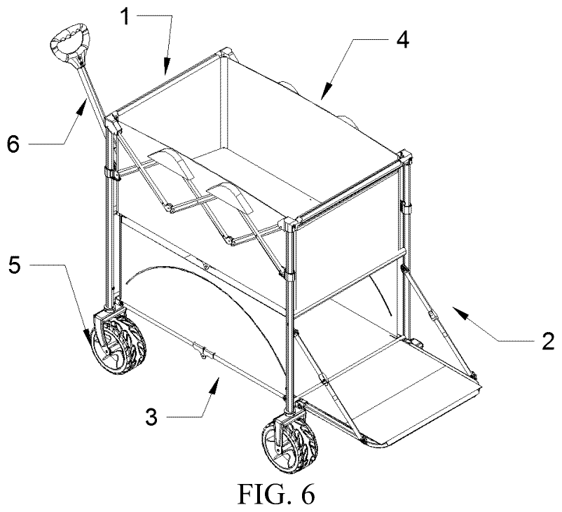

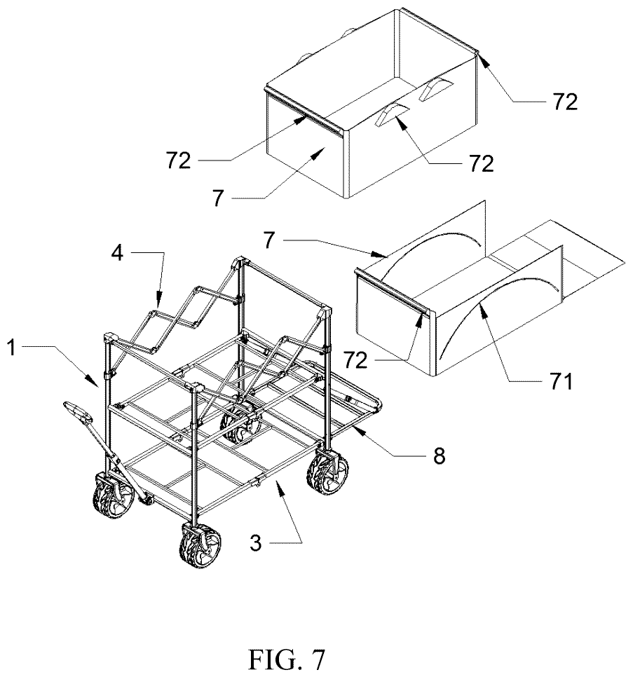

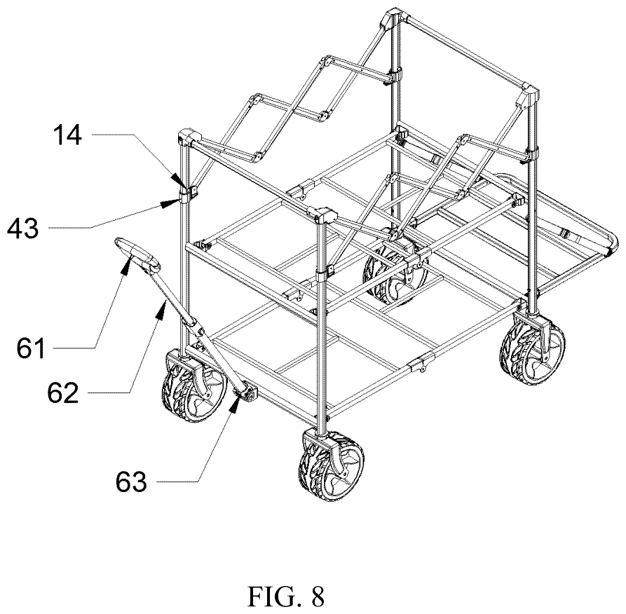

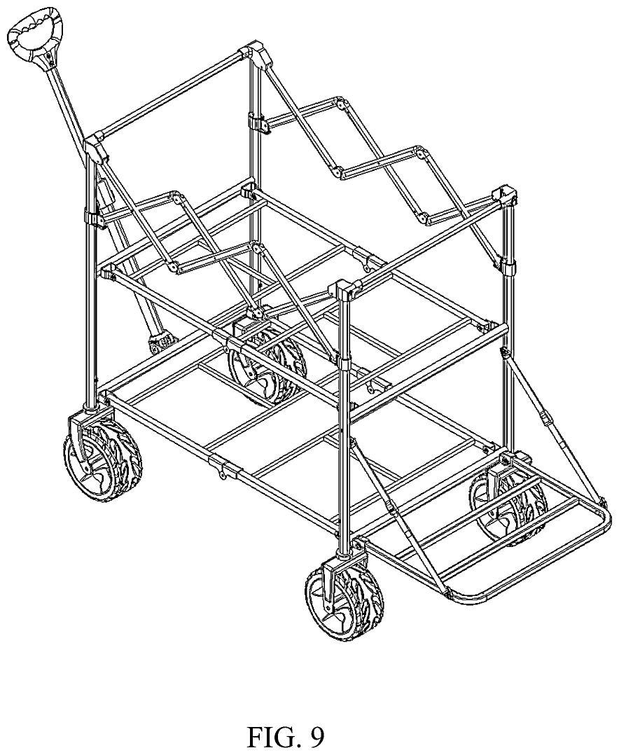

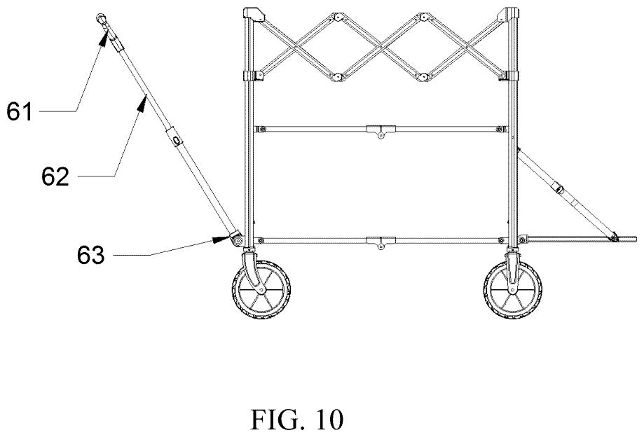

Different from Embodiment 1, as shown in FIG. 6-FIG. 10, in this embodiment, each of the side frames 4 of the double-layer horizontal folding cart comprises an upper fence 41.

In this embodiment, the visible areas 71 on the sides of the storage bag 7 on the lower layer are arc-shaped hollowed-out strips.

It should be noted that the above embodiments are merely preferred ones of the invention and are used to explain the technical principle of the invention. Those skilled in the art should understand that the invention is not limited to these specific embodiments described here, and those skilled in the art can make various changes, readjustments and substitutions without departing from the protection scope of the invention. Thus, although the invention has been described in detail with reference to the above embodiments, the invention is not limited to the above embodiments, and may include more other equivalent embodiments without departing from the concept of the invention. The scope of the invention is defined by the appended claims.

What is claimed is:

1. A double-layer horizontal folding cart, comprising:
a cart frame;
wherein the cart frame comprises a front frame, a back frame and a chassis riveted to a lower side of the front frame and a lower side of the back frame;
a plurality of casters are arranged at a bottom of the front frame and a bottom of the back frame;
a hand lever is arranged on the front frame;
the chassis comprises an upper layer and a lower layer, and each layer of the chassis comprises two bottom frames which are articulated symmetrically;
a baffle frame capable of being turned and opened to be horizontal is arranged on the back frame corresponding to the lower layer of the chassis.

2. The double-layer horizontal folding cart according to claim 1, further comprising side frames with a front end riveted to the front frame and a back end riveted to the back frame, wherein the side frames are located above the chassis, and a length of the side frames in a front-back direction is adjustable.

3. The double-layer horizontal folding cart according to claim 2, wherein each of the side frames comprises an upper fence with an adjustable length in the front-back direction, the upper fence is arranged above the upper layer of the chassis, upper ends of front and back sides of the upper fence are riveted to the front frame and the back frame respectively, and lower ends of the front and back sides of the upper fence are slidably connected with the front frame and the back frame respectively.

4. The double-layer horizontal folding cart according to claim 3, wherein the front frame and the back frame are identical in structure, the front frame comprises two support vertical tubes and at least one horizontal tube, two ends of the horizontal tube are connected with the two support vertical tubes, and the support vertical tubes are slidably connected with the lower ends of the front and back sides of the upper fence.

5. The double-layer horizontal folding cart according to claim 4, wherein each of the side frames further comprises sliders, the lower ends of the front and back sides of the upper fence are riveted to the sliders respectively, and the sliders are slidably connected with the support vertical tubes.

6. The double-layer horizontal folding cart according to claim 2, wherein each of the side frames further comprises a lower fence with an adjustable length in the front-back direction, the lower fence is arranged below the upper layer of the chassis, upper ends of front and back sides of the lower fence are slidably connected with the front frame and the back frame respectively, and lower ends of the front and back sides of the lower fence are riveted to front and back sides of the lower layer of the chassis respectively.

7. The double-layer horizontal folding cart according to claim 3, wherein each of the side frames further comprises a lower fence with an adjustable length in the front-back direction, the lower fence is arranged below the upper layer of the chassis, upper ends of front and back sides of the lower fence are slidably connected with the front frame and the back frame respectively, and lower ends of the front and back sides of the lower fence are riveted to front and back sides of the lower layer of the chassis respectively.

8. The double-layer horizontal folding cart according to claim 4, wherein each of the side frames further comprises a lower fence with an adjustable length in the front-back direction, the lower fence is arranged below the upper layer of the chassis, upper ends of front and back sides of the lower fence are slidably connected with the front frame and the back frame respectively, and lower ends of the front and back sides of the lower fence are riveted to front and back sides of the lower layer of the chassis respectively.

9. The double-layer horizontal folding cart according to claim 5, wherein each of the side frames further comprises a lower fence with an adjustable length in the front-back direction, the lower fence is arranged below the upper layer of the chassis, upper ends of front and back sides of the lower fence are slidably connected with the front frame and the back frame respectively, and lower ends of the front and back sides of the lower fence are riveted to front and back sides of the lower layer of the chassis respectively.

10. The double-layer horizontal folding cart according to claim 1, wherein the baffle frame is riveted to a lower end of the back frame, and left and right sides of the baffle frame are riveted to left and right sides of the back frame through length-adjustable connecting belts respectively.

11. The double-layer horizontal folding cart according to claim 2, wherein the baffle frame is riveted to a lower end of the back frame, and left and right sides of the baffle frame are riveted to left and right sides of the back frame through length-adjustable connecting belts respectively.

12. The double-layer horizontal folding cart according to claim 3, wherein the baffle frame is riveted to a lower end of the back frame, and left and right sides of the baffle frame are riveted to left and right sides of the back frame through length-adjustable connecting belts respectively.

13. The double-layer horizontal folding cart according to claim 4, wherein the baffle frame is riveted to a lower end of the back frame, and left and right sides of the baffle frame are riveted to left and right sides of the back frame through length-adjustable connecting belts respectively.

14. The double-layer horizontal folding cart according to claim 5, wherein the baffle frame is riveted to a lower end of the back frame, and left and right sides of the baffle frame are riveted to left and right sides of the back frame through length-adjustable connecting belts respectively.

15. The double-layer horizontal folding cart according to claim 10, wherein the hand lever is telescopic, and a lower end of the hand lever is rotatably connected with the front frame and is able to rotate forward and backward.

16. The double-layer horizontal folding cart according to claim 11, wherein the hand lever is telescopic, and a lower end of the hand lever is rotatably connected with the front frame and is able to rotate forward and backward.

17. The double-layer horizontal folding cart according to claim 12, wherein the hand lever is telescopic, and a lower end of the hand lever is rotatably connected with the front frame and is able to rotate forward and backward.

18. The double-layer horizontal folding cart according to claim 13, wherein the hand lever is telescopic, and a lower end of the hand lever is rotatably connected with the front frame and is able to rotate forward and backward.

19. The double-layer horizontal folding cart according to claim 1, further comprising two storage bags arranged on the two layers of the chassis respectively, wherein a back side of the storage bag on the lower layer is openable.

20. The double-layer horizontal folding cart according to claim 19, wherein visible areas are arranged on sides, corresponding to the side frames, of the storage bag on the lower layer.
